(19) United States
(12) Patent Application Publication
(10) Pub. No.: US 2006/0253337 A1
(43) Pub. Date: Nov. 9, 2006

(54) Sales management system and method

(75) Inventors: Li-Bo Ren, Tien-Jin City (CN); Chia-Chun Lee, Taipei (TW); Jeff Song, Taipei (TW); Win-Harn Liu, Taipei (TW)

Correspondence Address: FULBRIGHT AND JAWORSKI LLP, 555 S. FLOWER STREET, 41ST FLOOR, LOS ANGELES, CA, 90071, US

(73) Assignee: INVENTEC CORPORATION

(21) Appl. No.: 11/096,323

(22) Filed: Mar. 30, 2005

(51) Int. Cl. G06Q 30/00

(52) U.S. Cl. 705/26

(57) ABSTRACT

A sales management system and a sales management method are applied in a data processing device under a network environment to synchronously update sales information from different suppliers to a database by an information synchronization mechanism, to establish linkage between the suppliers and retailers through a supplier maintenance process, a retailer maintenance process and a supplier-retailer maintenance process in a logic control module, and to synchronize information with the retailers by the information synchronization mechanism. Therefore, only a set of client data and sales information needs to be maintained to provide sales and purchase information for a plurality of different suppliers and retailers.

### FIELD OF THE INVENTION

The present invention relates to sales management systems and methods, and more particularly, to a sales management system and method applied in a data processing device under a network environment.

### BACKGROUND OF THE INVENTION

As the functionality and popularity of electronic data processing devices gradually grow, using the electronic data processing devices for traditional commercial trading activities, which is also known as an electronic commerce (e-commerce) mode, has become a common technique in trading to reduce the trading cost and improve the trading efficiency. Generally, the e-commerce mode can be divided into several different categories according to the roles of the trading parties, such as Business-to-Business (B2B), Business-to-Customer (B2C), Client-to-Customer (C2C), and Customer-to-Business (C2B).

For example, the B2B e-commerce is usually performed between suppliers and retailers. Specifically, in the current various sales systems between suppliers and retailers, usually one supplier corresponds to multiple retailers, and a retailer has a plurality of downstream clients, such that the retailers and their clients form a sales channel for the supplier. However, there is still a problem in the conventional e-commerce technology between the supplier and the retailers, that is, the supplier and the retailers respectively employ different e-commerce techniques that are independent and do not correlate to each other.

For example, supplier A may have a plurality of downstream retailers a, b, c . . . , and supplier B may have downstream retailers b, c, d . . . , and so forth. In this example, suppliers A, B have retailers b, c in common; on the other hand, retailers b, c both correspond to the same suppliers A, B. However, the current e-commerce linking systems, especially those between different suppliers and retailers, are all different. In other words, even though suppliers A, B and retailers b, c have the same supplying and retailing pattern, the e-commerce systems thereof cannot be integrated due to lack of correlation between the systems.

The foregoing conventional e-commerce linking systems encounter the following problems. Firstly, from the retailer's point of view, a retailer needs to use different e-commerce systems corresponding to different suppliers at the same time, record all login information, and maintain data of its own and its clients in each of the e-commerce systems. As discussed above, many records of the data may be the same and need not be repeatedly managed. The more the e-commerce systems present between suppliers and retailers, the more serious the repeat situation is. Secondly, since the e-commerce systems differ in compatibility from each other, a user must switch between different e-commerce systems to perform the above process of managing information. This apparently requires a lot of software and hardware resources to run those different e-commerce systems and also increases the operation time. Moreover, due to lack of correlation between different suppliers, they cannot be integrated, such that the retailers need to spend a lot of time for integrating information provided from different suppliers. On the other hand, for the suppliers, as different retailers may have different e-commerce systems, this also causes difficulty in integration of different and independent e-commerce systems between the suppliers and their retailers.

Therefore, the problem to be solved here is to provide a sales management system and method, which can integrate current different e-commerce systems and trading modes to an intermediate platform such that suppliers and retailers only need to maintain a set of client data and sales information that are sufficient to provide required purchase and sales information for a plurality of different suppliers and retailers.

### SUMMARY OF THE INVENTION

In light of the above drawbacks in the prior art, a primary objective of the present invention is to provide a sales management system and method, which can provide required purchase and sales information for a plurality of different suppliers and retailers through the use of a single integrated intermediate platform.

Another objective of the present invention is to provide a sales management system and method, using a single integrated intermediate platform to allow suppliers and retailers to maintain only a set of client data and sales information.

A further objective of the present invention is to provide a sales management system and method, using a single integrated intermediate platform, such that new suppliers and retailers can join the sales management system without requiring system integration therebetween.

In order to accomplish the above and other objectives, the present invention proposes a sales management system applied in a data processing device under a network environment. The sales management system includes: a database for storing sales related information of suppliers and retailers; an information synchronization module for synchronously updating information provided by the suppliers and retailers to the database; and a logic control module comprising a supplier maintenance module, a retailer maintenance module, and a supplier-retailer linkage module. The supplier maintenance module is used to establish basic data of the suppliers in the database so as for linkage of information between the suppliers and retailers. The retailer maintenance module is used to establish information of logical retailers, which relate to corresponding physical retailers, in the database. The supplier-retailer linkage module is used to establish linkage of information between the corresponding suppliers and retailers after their information has been established by the supplier maintenance module and the retailer maintenance module.

With the use of the sales management system in the present invention, a sales management method can be performed by the steps of: firstly, synchronously updating information provided by suppliers and retailers to the database; and establishing linkage between the suppliers and retailers by a supplier maintenance process, a retailer maintenance process and a supplier-retailer linkage process. The supplier maintenance process includes establishing basic data of the suppliers in the database so as for linkage of information between the suppliers and retailers. The retailer maintenance process includes establishing information of logical retailers, which relate to corresponding physical retailers, in the database. The supplier-retailer linkage process includes establishing linkage of information between the corresponding suppliers and retailers after their information has been established by the supplier maintenance module and the retailer maintenance module.

Unlike the conventional e-commerce system, the sales management system and method in the present invention provide a mechanism for establishing linkage between suppliers and retailers by synchronously updating information provided from the suppliers and retailers to the database and by utilizing the supplier maintenance process, the retailer maintenance process and the supplier-retailer linkage process. Thus, only a set of client data and sales information needs to be maintained to provide required sales and purchases information for a plurality of different suppliers and retailers. Moreover, new suppliers and retailers can join the sales management system without requiring system integration therebetween, such that the e-commerce cost is reduced and the sales management efficiency is improved.

### BRIEF DESCRIPTION OF THE DRAWINGS

The present invention can be more fully understood by reading the following detailed description of the preferred embodiments, with reference made to the accompanying drawings, wherein:

FIG. 1 is a systemic block diagram showing architecture of a sales management system according to the present invention;

FIG. 2 is a flowchart showing steps of a sales management method according to the present invention;

FIG. 3 is a flowchart showing detailed steps of synchronously updating information and performing a supplier maintenance process in FIG. 2;

FIG. 4 is a flowchart showing detailed steps of performing a retailer maintenance process in FIG. 2; and

FIG. 5 is a flowchart showing detailed steps of performing a supplier-retailer linkage process in FIG. 2.

### DETAILED DESCRIPTION OF THE PREFERED EMBODIMENTS

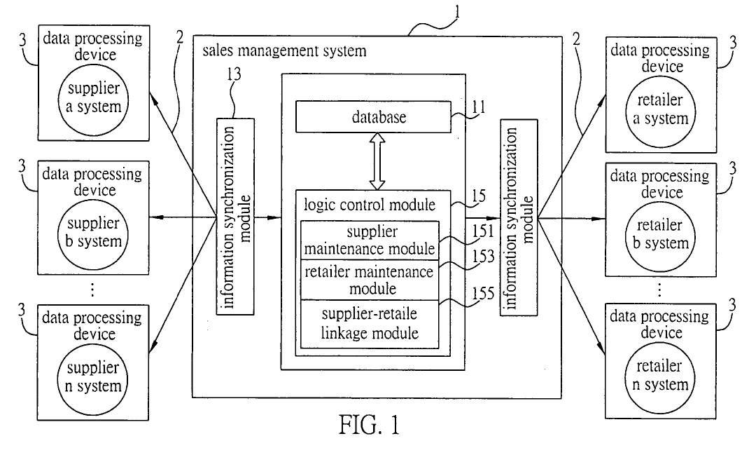

FIG. 1 is a systemic block diagram showing architecture of a sales management system proposed in the present invention. As shown in FIG. 1, the sales management system 1 in the present invention is applied in a data processing device 3 under network environment 2. In this embodiment, the network environment 2 can be the Internet or an extranet, and the data processing device 3 can be a server-end data processing device for being connected through the network environment 2 to user-end data processing devices 3 where systems of suppliers a, b . . . n and retailers a, b . . . n are situated so as to transmit and access data. In other words, in this embodiment, the sales management system 1 in the present invention is used in the network environment 2 with client/server architecture; however, the sales management system 1 in the present invention may also be used in other types of network environments such as distributed network architecture. Moreover, the data processing devices 3 can be for example workstations, personal computers, notebook computers, personal digital assistants or other devices having network connection and data processing functions.

The sales management system 1 in the present invention includes a database 11, an information synchronization module 13, and a logic control module 15.

The database 11 is used to store sales related information of suppliers and retailers. In this embodiment, the supplier information includes basic information of the suppliers such as supplier names, supplier types, contact details of the suppliers, identification data of the suppliers, and so on; basic information of supplied goods such as names of the supplied goods, contents of the supplied goods, attributes of the supplied goods, specifications of the supplied goods, prices of the supplied goods, stocks of the supplied goods, and so on; and information relating to sales activities such as special sales activities of the suppliers, launch of new goods, and so on.

Moreover, the retailer information includes basic information of the retailers such as retailer names, retailer types, contact details of the retailers, identification data of the retailers, and so on; information of goods required by the retailers such as names of the required goods, contents of the required goods, attributes of the required goods, specifications of the required goods, prices of the required goods, quantities of the required goods, and so on; and information relating to sales activities of the retailers such as a sales status of each goods of the retailers, special sales activities of the retailers, and so on.

It should be noted that, in this embodiment, the database 11 is a correlation database for improving the efficiency of searching and retrieving information. By establishing such correlation database, when a user enters any type of the foregoing information, the database 11 can quickly find the corresponding data. It should be understood that all the foregoing information contents only serve as examples and can be more detailed in practice. Further, the information contents may also include other information contents; however to make the description concise, only information relating to sales management and processing in the present invention is illustrated. Moreover, the correlation database may have various types of system architecture, and its construction employs conventional technology and is thus not to be further detailed herein.

The information synchronization module 13 is used to synchronously update information provided by the suppliers and retailers to the database 11. In this embodiment, the information synchronization module 13 is an application program module that can be connected to the data processing devices 3 of the suppliers and retailers in a remote access manner and access sales related data stored in databases (not shown) of the data processing devices 3 of the suppliers and retailers, wherein the data can be for example the foregoing sales related information of suppliers and retailers stored in the database 11. After the sales related information of the suppliers and retailers is accessed, a search is conducted in database 11 for information corresponding to the sales related information of the suppliers and retailers. Finally, the sales related information of the suppliers and retailers obtained from the databases in the data processing devices 3 of the suppliers and retailers is stored in corresponding data fields of the database 11 so as to establish sales related information of the suppliers and retailers in the database 11.

Moreover, in one embodiment of the present invention, the sales related information of the suppliers and retailers obtained from the databases in the data processing devices 3 of the suppliers and retailers would replace the corresponding original information in the database 11, and the original information would be stored in history data fields of the database 11 for future reference. In another embodiment of the present invention, the sales related information of the suppliers and retailers obtained from the databases in the data processing devices 3 of the suppliers and retailers would replace the corresponding original information in the database 11, and the information after replacement would be assigned to a new version of information. By setting the version of information, updating records of the sales related information of the suppliers and retailers can be efficiently searched in the future.

The logic control module 15 includes a supplier maintenance module 151, a retailer maintenance module 153 and a supplier-retailer linkage module 155.

The supplier maintenance module 151 is used to establish basic data of the suppliers in the database 11 so as for linkage of information between the suppliers and retailers. As above described, in this embodiment, after the information synchronization module 13 is connected to the data processing devices 3 of the suppliers and retailers in a remote access manner, and accesses the sales related information stored in the databases of the data processing devices 3 of the suppliers and retailers, a search is conducted in the database 11 for information corresponding to the sales related information of the suppliers and retailers, and finally the sales related information obtained from the databases in the data processing devices 3 of the suppliers and retailers is stored in the corresponding data fields of the database 11 so as to establish sales related information of the suppliers and retailer in the database 11. On the other hand, since the database 11 is a correlation database, information stored in the database 11 must be correlated. For instance, to achieve information synchronization, the information synchronization module 13 processes the sales related information of the suppliers and retailers to be in the same file format, such as converting .doc and .xls files into .txt files to be stored, converting .bmp files into .jpg files to be stored, and so forth. The format of the stored files can be adjusted according to the user's requirement.

The retailer maintenance module 153 is used to establish information of logical retailers, which relate to corresponding physical retailers, in the database 11. In this embodiment, the logical retailers correspond to the physical retailers. For example, the retailer a pertains to the suppliers a, b; however, from the perspective of the suppliers a, b, they each has a retailer a. In fact, the retailer a pertaining to the supplier a or b is the same retailer. Thus, in the sales management system 1 according to the present invention, a corresponding logical retailer a would be established for the physical retailer a by the supplier-retailer linkage module 155, that is, for either the suppliers a, b, all sales information of the physical retailer a is also stored in database fields of the logical retailer a, such that the physical retailer a obtains linkage to the suppliers a, b through the logical retailer a. Furthermore, the logical retailer can be assigned a particular name of logical retailer if necessary, which can be the name of the physical retailer or a name only used for the logical retailer.

The supplier-retailer linkage module 155 is used to establish linkage of information between the corresponding suppliers and retailers after their information has been established by the supplier maintenance module 151 and the retailer maintenance module 153. As above described, when a supplier wishes to be linked to a retailer, a physical retailer is selected and then the supplier-retailer linkage module 155 determines whether the physical retailer corresponds to the logical retailer; if yes, linkage is established between the supplier and the logical retailer. Thus, the supplier linked to the logical retailer is equivalent as communicating with the physical retailer. Since different suppliers can communicate with physical retailers through the same set of logical retailers, a single integrated sales management system is achieved, providing a one-to-one, one-to-multiple, multiple-to-one and/or multiple-to-multiple sales connection.

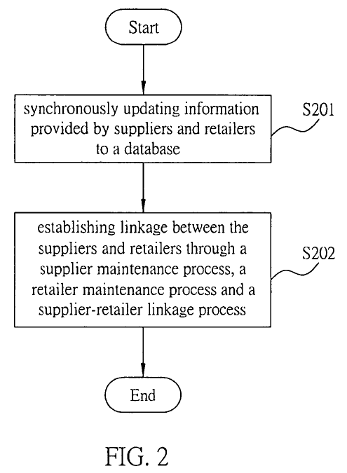

FIG. 2 is a flowchart showing steps of a sales management method in the present invention through the use of the sales management system 1.

As shown in FIG. 2, in step S201, information provided by suppliers and retailers is synchronously updated to the database 11.

In step S202, linkage between the suppliers and retailers is established through a supplier maintenance process, a retailer maintenance process, and a supplier-retailer linkage process. The supplier maintenance process includes establishing basic data of the suppliers in the database 11 so as for linkage of information between the suppliers and retailers. The retailer maintenance process includes establishing information of logical retailers, which relate to corresponding physical retailers, in the database 11. The supplier-retailer linkage process includes establishing linkage of information between the corresponding suppliers and retailers after their information has been established by the supplier maintenance module 151 and the retailer maintenance module 153.

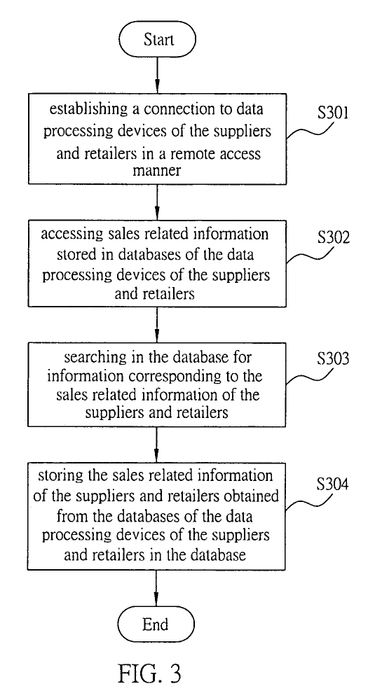

FIG. 3 is a flowchart showing detailed steps of synchronously updating information and performing the supplier maintenance process in FIG. 2.

As shown in FIG. 3, in step S301, a connection is established to data processing devices 3 of the suppliers and retailers in a remote access manner, then proceeding to step S302.

In step S302, sales related information stored in databases of the data processing devices 3 of the suppliers and retailers is accessed, then proceeding to step S303.

In step S303, a search is conducted in the database 11 for information corresponding to the sales related information of the suppliers and retailers, then proceeding to step S304.

In step S304, the sales related information of the suppliers and retailers obtained from the databases of the data processing devices 3 of the suppliers and retailers is stored in corresponding data fields of the database 11 so as to establish sales related information of the suppliers and retailers in the database 11.

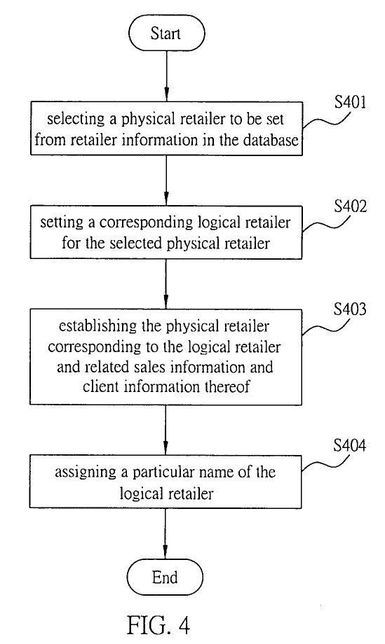

FIG. 4 a flowchart showing detailed steps of performing the retailer maintenance process in FIG. 2.

As shown in FIG. 4, in step S401, a physical retailer to be set is selected from retailer information in the database 11, then proceeding to step S402.

In step S402, a corresponding logical retailer is set for the selected physical retailer, then proceeding to step S403.

In step S403, the physical retailer corresponding to the logical retailer and related sales information and client information thereof are established, then proceeding to S404.

In step S404, a particular name of the logical retailer is assigned.

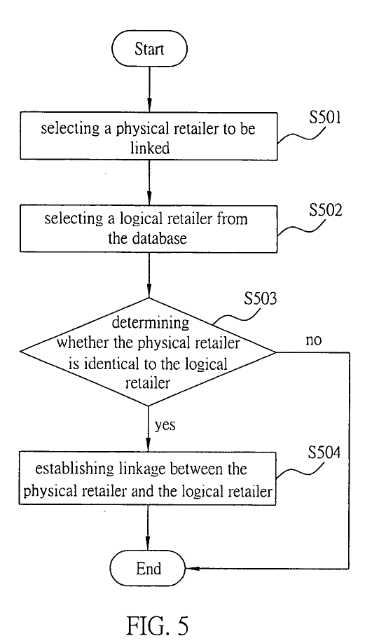

FIG. 5 is a flowchart showing detailed steps of performing the supplier-retailer linkage process in FIG. 2.

As shown in FIG. 5, in step S501, a physical retailer to be linked is selected, then proceeding to step S502.

In step S502, a logical retailer is selected from the database 11, then proceeding to step S503.

In step S503, it determines whether the physical retailer is identical to the logical retailer. If yes, proceed to step S504; if no, terminate the process.

In step S504, the physical retailer is linked to the logical retailer.

Therefore, the sales management system and method in the present invention provide a mechanism for establishing linkage between suppliers and retailers by synchronously updating information provided from the suppliers and retailers to the database and by utilizing the supplier maintenance process, the retailer maintenance process and the supplier-retailer linkage process. Thus, only a set of client data and sales information needs to be maintained to provide required sales and purchases information for a plurality of different suppliers and retailers. Moreover, new suppliers and retailers can join the sales management system without requiring system integration therebetween, such that the e-commerce cost is reduced and the sales management efficiency is improved.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A sales management system applied in a data processing device under a network environment, comprising:
a database for storing sales related information of suppliers and retailers;
an information synchronization module for synchronously updating information provided by the suppliers and retailers to the database; and
a logic control module comprising a supplier maintenance module, a retailer maintenance module and a supplier-retailer linkage module.

2. The sales management system of claim 1, wherein the supplier maintenance module is for establishing basic data of the suppliers in the database so as for linkage of information between the suppliers and retailers.

3. The sales management system of claim 1, wherein the retailer maintenance module is for establishing information of logical retailers, which relate to corresponding physical retailers, in the database.

4. The sales management system of claim 3, wherein particular names of the logical retailers are assigned.

5. The sales management system of claim 1, wherein the supplier-retailer linkage module is for establishing linkage of information between the corresponding suppliers and retailers after their information has been established by the supplier maintenance module and the retailer maintenance module.

6. The sales management system of claim 5, wherein the supplier-retailer linkage module determines whether physical retailers correspond to logical retailers, and if yes, the supplier-retailer linkage module establishes linkage between the suppliers and the logical retailers.

7. The sales management system of claim 1, wherein the information synchronization module processes the sales related information of the suppliers and retailers to be in the same file format.

8. A sales management method applied in a data processing device under a network environment, comprising the steps of:
synchronously updating information provided by suppliers and retailers to a first database; and
establishing linkage between the suppliers and retailers by a supplier maintenance process, a retailer maintenance process, and a supplier-retailer linkage process.

9. The sales management method of claim 8, wherein the supplier maintenance module comprises establishing basic data of the suppliers in the first database so as for linkage of information between the suppliers and retailers.

10. The sales management method of claim 9, wherein synchronously updating of the information and the supplier maintenance process are performed by the steps of:
establishing a connection to data processing devices of the suppliers and retailers in a remote access manner;
accessing sales related information stored in second databases of the data processing devices of the suppliers and retailers;
searching in the first database for information corresponding to the sales related information of the suppliers and retailers; and
storing the sales related information obtained from the second databases of the data processing devices of the suppliers and retailers in the first database.

11. The sales management method of claim 8, wherein the retailer maintenance process comprises establishing information of logical retailers, which relate to corresponding physical retailers, in the first database.

12. The sales management method of claim 11, wherein the retailer maintenance process comprises the steps of:
selecting a physical retailer to be set from retailer information in the first database;
setting a corresponding logical retailer for the selected physical retailer;
establishing the physical retailer corresponding to the logical retailer and related sales information and client information thereof; and
assigning a particular name of the logical retailer.

13. The sales management method of claim 8, wherein the supplier-retailer linkage process comprises establishing linkage of information between the corresponding suppliers and retailers after their information has been established in the first database.

14. The sales management method of claim 13, wherein the supplier-retailer linkage process comprises the steps of:
selecting a physical retailer to be linked;
selecting a logical retailer from the first database;
determining whether the physical retailer is identical to the logical retailer; and
establishing linkage between the physical retailer and the logical retailer if the physical retailer and the logical retailer are identical.
